(19) United States
(12) Patent Application Publication
(10) Pub. No.: US 2017/0050102 A1
(43) Pub. Date: Feb. 23, 2017

(54) MODULAR FITNESS ACTIVITY FACILITY AND METHOD FOR PROVIDING SAME

(71) Applicant: FissionFit, LLC, Sterling Heights, MI (US)

(72) Inventor: Travis Kelly, Sterling Heights, MI (US)

(21) Appl. No.: 15/242,996

(22) Filed: Aug. 22, 2016

Related U.S. Application Data
(60) Provisional application No. 62/208,637, filed on Aug. 22, 2015.

(51) Int. Cl. A63B 71/04; G05B 15/02; G07C 9/00; E04H 1/00; E04H 1/12

(52) U.S. Cl. CPC A63B 71/04; E04H 1/005; E04H 1/125; G07C 9/00103; G05B 15/02

(57) ABSTRACT

A modular fitness activity facility can include an enclosed structure defined by four connecting walls, one of the four connecting walls including an entrance having a locking mechanism restricting access to an interior of the enclosed structure. Fitness equipment and non-fitness materials can be removably disposed within the interior of the enclosed structure to configure the modular fitness activity facility in response to an indication by a user made using a computer portal for browsing available fitness equipment and non-fitness materials. Preference data associated with the indicated combination of equipment or materials can be stored in connection with a user profile associated with the user for subsequent reference. The fitness equipment and non-fitness materials can be removed from the enclosed structure to configure the modular fitness activity facility for use by a different user.

### CROSS-REFERENCE TO RELATED APPLICATIONS

This application claims the benefit of U.S. Provisional Application No. 62/208,637, filed Aug. 22, 2015, entitled “Method for Training, Coaching, Rehearsing, Instructing or Self-Instructing,” the disclosure of which is herein incorporated by reference.

### TECHNICAL FIELD

The present disclosure relates in general to fitness activities, and, more particularly, to modular fitness activity facilities and methods for providing same.

### BACKGROUND

Fitness facilities attract clients interested in improving their physical health either by individual exercise or guided exercise directed by a personal trainer or group instructor. Typically, fitness facilities include large, open spaces filled with cardiovascular, weight, aerobic, and/or other fitness equipment accessible by any user at any time. Some fitness facilities may also include separate areas for focused training. Of particular note in providing a fitness facility are the types of equipment and materials desired by a user and the nature of the space in which the user exercises.

### SUMMARY

Disclosed herein are modular fitness activity facilities and methods for providing same.

In an embodiment, a modular fitness activity facility comprises an enclosed structure defined by four connecting walls, one of the four connecting walls including an entrance, the entrance having a locking mechanism restricting access to an interior of the enclosed structure by persons without corresponding access credentials. The modular fitness activity facility further comprises at least one fitness equipment and at least one non-fitness material removably disposed within the interior of the enclosed structure. One or more of the at least one fitness equipment or the at least one non-fitness material is removably disposed within the interior of the enclosed structure in response to an indication by a user, the indication including a request for the one or more of the at least one fitness equipment or the at least one non-fitness material.

In an embodiment, a method for providing a modular fitness activity facility comprises providing a computer portal accessible by computer devices, the computer portal configured to include a plurality of fitness equipment options and a plurality of non-fitness material options selectable by users to indicate configurations of the modular fitness activity facility. The method further comprises receiving, at a first computing device, a first request from a first user, the first request including an indication of at least one fitness equipment and at least one non-fitness material to be included within an interior of an enclosed structure of the modular fitness activity facility, the first request transmitted by a second computing device of the first user in response to the first user accessing the computer portal using the second computing device. The method further comprises configuring the modular fitness activity facility by removably disposing the at least one fitness equipment and the at least one non-fitness material indicated in the first request within the interior of the enclosed structure of the modular fitness activity facility.

In an embodiment, a modular fitness activity facility comprises an enclosed structure defined by four connecting walls, one of the four connecting walls including an entrance, the entrance having a locking mechanism restricting access to an interior of the enclosed structure by persons without corresponding access credentials, the interior of the enclosed structure removably including a combination of equipment including a plurality of cardiovascular equipment, strength-resistance equipment, aerobic equipment, therapeutic equipment, recreational equipment, technological materials, communications materials, ambiance materials, or safety materials. The combination of equipment is selected by a user having the corresponding access credentials, the selection of the combination of equipment being indicated by a first request generated using a computer portal for browsing available equipment for removable inclusion within the interior of the enclosed structure, the computer portal configured to store preference data associated with the selection of the combination of equipment in connection with a user profile associated with the user such that the user can reference the preference data to cause a second request similar to the first request to be generated using the computer portal. The interior of the enclosed structure is configured to include the combination of equipment in response to the user selection of the combination of equipment being indicated using the computer portal such that the interior of the enclosed structure can be emptied after a use by the user in order to configure the interior of the enclosed structure to include a second combination of equipment selected by a second user.

These and other aspects of the present disclosure are disclosed in the following detailed description of the embodiments, the appended claims and the accompanying figures.

### BRIEF DESCRIPTION OF THE DRAWINGS

The invention is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is an illustration of an example modular fitness activity facility in accordance with embodiments of the present disclosure.

FIG. 2 is a depiction of a graphical user interface displayed on an example computing device usable to transmit or otherwise process requests for a modular fitness activity facility.

FIG. 3 is a flowchart showing an example of a method for providing a modular fitness activity facility in accordance with embodiments of the present disclosure.

### DETAILED DESCRIPTION

Persons who visit fitness facilities to exercise, referred to generally herein as ‘users’ of the equipment, materials, facilities, or the like, may from time to time desire a private space within which to exercise. For example, certain users may have self-confidence or other issues that drive them to improve their physical conditions by going to a fitness facility, but which inhibit their activities once present at the facility because they are too embarrassed to exercise in front of other users, whether due to body image issues, concerns that they are incorrectly using the fitness equipment, or other reasons. Because fitness facilities typically provide nothing more than a large, open area for users to collectively exercise, users such as those described immediately above may not be able to achieve their exercise goals. As such, it would be desirable for a fitness facility to include a private area within which users could exercise, either individually or under the supervision of a personal trainer.

Furthermore, many users who visit fitness facilities desire to engage in exercise routines that include a number of different exercises, thereby requiring access to many kinds of exercise equipment. For example, a user may be guided by a personal trainer to undergo a twenty-minute cardiovascular warmup using a treadmill machine and subsequently repeat circuit exercises including chest, back, arm, and leg free-weight or weight machine activities. It is thus highly desirable that fitness facilities include diverse types of equipment to facilitate the many types of exercises users may seek to perform. However, this problem may be complicated where private areas are made available for user exercise. That is, to the extent some fitness facilities may include private workout areas, they offer meager selections of exercise equipment that inevitably require the user to leave the private area to perform his or her exercise routine.

Embodiments of the present disclosure include a modular fitness activity facility and a method of providing same. The modular fitness activity facility can include an enclosed structure for providing a private area usable for individual or guided exercise. In some embodiments, the enclosed structure of the modular fitness activity facility can be customized based on a user's needs or desires. For example, a user can indicate via a computerized portal the types of equipment that he or she wants a modular fitness activity facility to include, which may, for example, be one or more of cardiovascular equipment, strength-resistance equipment, aerobic equipment, therapeutic equipment, or the like. In some implementations, only facility-staffed or contracted personal trainers may use the computerized portal. In some embodiments, the user can request customizations to the modular fitness activity facility to include technology, communications, ambiance safety, or other equipment. Upon receiving instructions for customizing a modular fitness activity facility via the computer portal or other means, the modular fitness activity facility can be customized by removing unrequested equipment and materials therefrom and temporarily installing requested equipment and materials therein.

Referring now to the figures, an enclosed structure of a modular fitness activity facility is shown at 100. The structure 100 is a private area accessible only by a user of a fitness facility, a personal trainer of the user, or other authorized persons, such as personnel of the fitness facility. The structure 100 is an enclosure included within a larger structure, such as a fitness facility. Accordingly, a fitness facility can include any number of the structures 100. The structure 100 can be an area enclosed by four connecting walls and a ceiling or only by the four walls. An entrance to the structure 100 is provided by way of a door having locking mechanisms 112 for preventing access within the structure 100 to persons without corresponding access credentials. For example, a key, password, or other form of credentials may be provided to the designated user of the structure 100 and his or her personal trainer, to the extent applicable. Although the structure 100 is depicted as a generally rectangular shape, any dimensions or shape can be used to provide the structure 100.

The structure 100 is modular in that it can include customized fitness equipment for the user to use in conducting an exercise routine within the structure 100. In some embodiments, the fitness equipment can include cardiovascular equipment 102. For example, the cardiovascular equipment 102 can be one or more of treadmills, elliptical machines, recumbent bicycles, upright bicycles, assault bicycles, spin bicycles, concept two rower machines, or the like. In some embodiments, the fitness equipment can include strength-resistance equipment 104. For example, the strength-resistance equipment 104 can be one or more of squat racks, Smith machines, dumbbells, barbells, resistance tubes, Olympic bars, weight trees, other free-weight systems or weight machine systems, or the like.

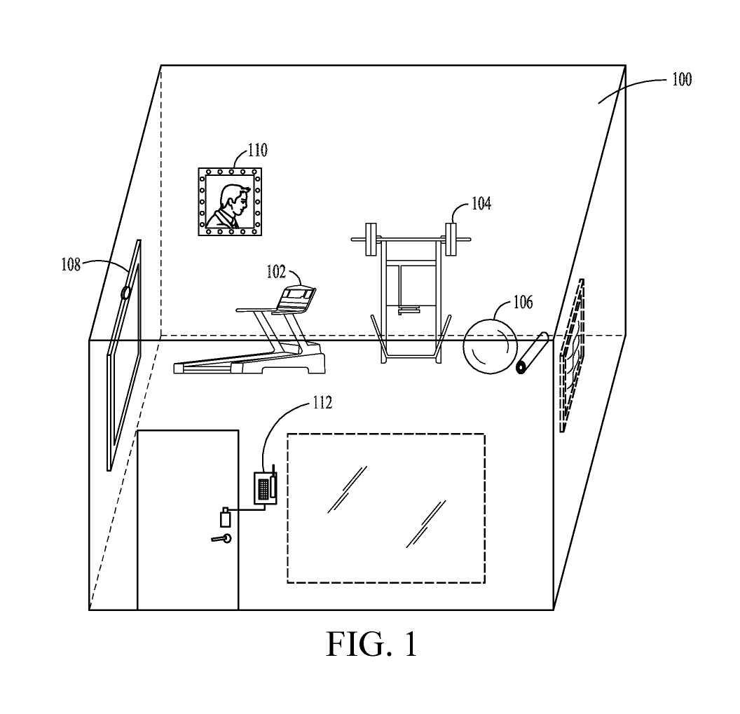

The structure 100 can include fitness equipment other than cardiovascular equipment 102 or strength-resistance equipment 104. In some embodiments, the fitness equipment can include aerobic equipment 106. For example, the aerobic equipment 106 can be one or more of suspension training systems, plyometric boxes, balancing or stability equipment, agility ladders, medicine balls, battle ropes, climbing ropes, mats, agility tools, stretching equipment such as cages, or the like. In some embodiments, the structure 100 can include other types of fitness equipment not shown in FIG. 1, such as therapeutic equipment, recreational equipment, or miscellaneous equipment. The therapeutic equipment can, for example, be one or more of foam or rumble rollers, exercise balls, saunas (to the extent permitted by the physical and locational characteristics of the structure 100), or the like. The recreational equipment can, for example, be one or more of golf simulators with or without computing components for measuring user activity, golf session training systems for improving user strength, balance, power, or flexibility, or the like. The miscellaneous equipment can, for example, be a water dispenser or other non-fitness equipment.

In some embodiments, the structure 100 can also include various furnishings, equipment, or other materials beyond those directly related to fitness activities (collectively hereafter referred to as ‘non-fitness materials’), which, in some embodiments, may be selectable or otherwise customizable based on the needs or desires of a user. Although various types of non-fitness materials are described below by example, it is understood that the structure 100 may include additional or different non-fitness materials, to the extent supported by the physical dimensions or other physical characteristics of the structure 100.

In some embodiments, the non-fitness materials can include technological or communications-related materials 108. For example, the structure 100 can be one or more of televisions, such as smart-televisions connectable to the Internet via wired or wireless communications means, chalkboards or whiteboards usable for writing down notes or drawing pictures that may be related to activities performable within the structure 100, wireless or wired cameras that may include Internet-connectivity for recording or streaming interactive fitness activities, wireless or wired speakers for playing music from a playback device located within or outside of the structure 100, a communication device such as an intercom or telephone for communicating with a central line or lines accessible by other structures 100, or the like.

In some embodiments, the non-fitness materials can include ambiance materials 110. For example, the structure 100 can be one or more of light or color changing (e.g., LED) picture frames for attracting user attention to inspiring quotes or imagery or targeted advertisements contained within the frames (the contents of which frames may change using a computing device, for example, so as to direct targeted quotes, imagery, or advertisements based on preferences or identified characteristics of the user of the structure 100), light strips that may include color changing features (e.g., LED) affixed about the structure 100 for aesthetic improvement, mirrors, or the like.

In some embodiments, the non-fitness materials can include safety materials 112. For example, the structure 100 can be one or more of a closed circuit camera for monitoring the safety of a user of the structure 100, a door locking including a key card verification mechanism or other coded security mechanism for restricting access to authorized personnel, a request assistance interface, such as a button, for transmitting a signal indicative of the user's need for assistance to a central office, or the like.

Because the structure 100 is part of a modular fitness activity facility that can be configured to a user's desires or needs, the interior of the structure 100 can be emptied after the user has completed his or her exercise routine or otherwise exited the structure 100. The structure 100 can thereafter be reconfigured to include other fitness equipment or non-fitness materials selected by a different user.

The fitness facility within which the modular fitness activity facility is located can include other areas beyond the multiple modular fitness activity facilities. For example, the fitness facility can include a unisex changing and washing facility having a central locker room and private changing or washing areas located along the perimeter of the unisex changing and washing facility. In some embodiments, the private changing or washing areas can include changing tables for resting user clothing on, a mirror, washroom features such as toilets, sinks, showers, or the like. The private changing or washing areas can be enclosed with doors having locking mechanisms. In some embodiments, the locking mechanisms can include bolt locks or other safety features for restricting access to the area. In some embodiments, the central locker room can include safety features, for example, closed circuit monitoring to monitor the safety of the users in the area or request assistance interfaces, such as buttons, for requesting facility personnel to assist the user with matters, for example, inability to enter their locker.

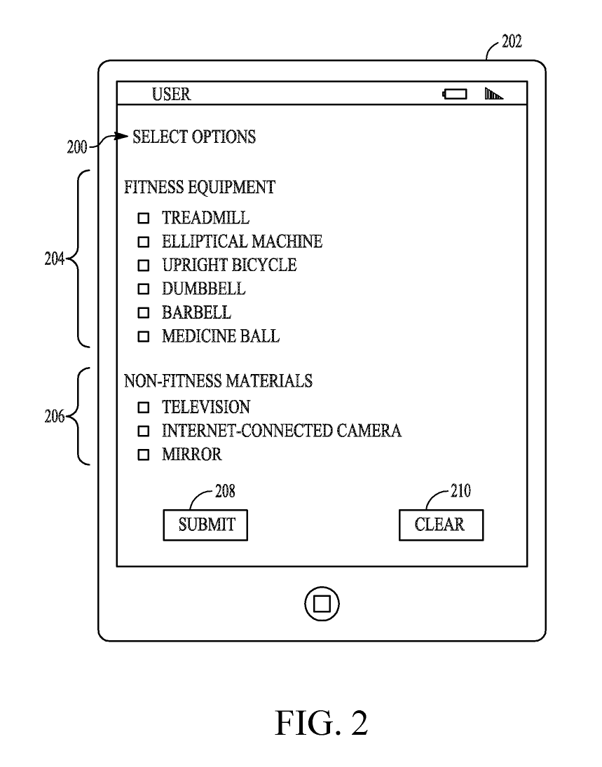

FIG. 2 is a depiction of a graphical user interface 200 displayed on an example computing device 202 usable to transmit or otherwise process requests for a modular fitness activity facility. The fitness equipment and non-fitness materials described above with respect to the structure 100 of the modular fitness activity facility can be configurably selected by the user through a computer portal including the graphical user interface 200. Thus, using the computer portal, the user can indicate the specific fitness equipment and/or non-fitness materials he or she desires to be included within the structure 100. The indicated fitness equipment and/or non-fitness materials can be communicated to a second computing device accessible by personnel of a fitness facility at which the modular fitness activity facility is located so that they can configure the interior of the structure 100 to include the indicated fitness equipment and/or non-fitness materials.

The graphical user interface 200 can be included as a part of a web page or other online content element. In some embodiments, the graphical user interface 200 can include a list of fitness equipment and/or non-fitness materials selectable by a user of the computing device 202 used to view the graphical user interface 200. The selectable items of graphical user interface 200 can be represented in a variety of forms, including, but not limited to, checkboxes, radio buttons, drop-down menus, or the like. The graphical user interface 200 can be output to a display of the computing device 202 using CSS, HTML, AngularJS, or any other programming language configured to generate display output as part of a webpage or web application.

In some embodiments, the graphical user interface 200 can include multiple sections for dividing categories of selectable objects. For example, the graphical user interface 200 can include a first section 204 for listing selectable options of fitness equipment and a second section 206 for list selectable options of non-fitness materials. A user of the computing device 202 can choose one or more options from one or more of the first section 204 or the second section 206 in order to indicate the fitness equipment and non-fitness materials to be used for configuring a modular fitness activity facility at the fitness facility having the second computing device to which the selections are transmitted. In some embodiments, each of the first section 204 and the second section 206 can include sub-sections for further organizing the types of fitness equipment and non-fitness materials by category. For example, the first section 204 can include one or more sub-sections for cardiovascular equipment, strength-resistance equipment, etc., and the second section 206 can include one or more sub-sections for technological materials, communications materials, etc.

The graphical user interface 200 can include action buttons or similar elements for processing selections indicated by a user of the computing device 202. In some embodiments, the graphical user interface can include a submit action button 208 and a clear action button 210. The submit action button 208, when toggled by a user of the computing device 202, can cause a request indicative of the selected fitness equipment and non-fitness materials to be generated and transmitted to a second computing device located at the fitness facility including the modular fitness activity facility to be configured. The clear action button 210, when toggled by the user of the computing device 202, can cause the selections indicated in the graphical user interface 200 to be removed such that the graphical user interface 200 can return to a pre-selection state. The graphical user interface 200 can include additional or substitute action buttons or similar elements in addition to or instead of those described herein.

The computing device 202 can be any computer capable of rendering the graphical user interface 200 and connecting to the Internet to submit a request from the graphical user interface 200. In some embodiment, the computing device can be a mobile device, such as a smartphone, tablet computer, laptop computer, personal digital assistant, or the like. In some embodiments, the computing device 202 can be any computer having a processor and memory that is capable of accessing the Internet, including a desktop computer, a cellular telephone other than a smart phone, video game console, or the like. The computing device 202 can access a server hosting the web page generating the graphical user interface 200 using wired or wireless communication means, including local area network connections, wide area network connections, Ethernet connections, Wi-Fi connections, or the like.

In some implementations, the computer portal can allow a user to reserve a modular fitness activity facility without having to be a facility-staffed or contracted personal trainer. In some implementations, the computer portal can include a system for processing payments, which, for example, may allow a user to prepay (e.g., weekly, monthly, quarterly, semi-annually, or annually) at a defined rate. In some implementations, a system for processing payments through the computer portal can monitor prepayment amounts such that overpayments can roll over the funds to a subsequent prepayment period until they are used by the user.

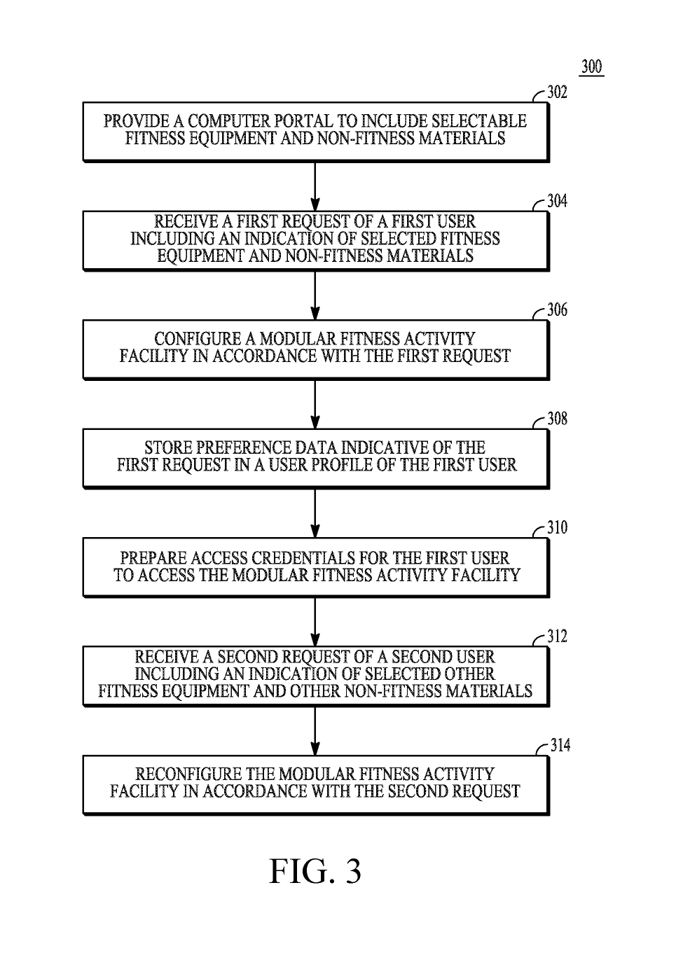

FIG. 3 is a flowchart showing an example of a method 300 for providing a modular fitness activity facility in accordance with embodiments of the present disclosure. In some embodiments, method 300 can be implemented using the features described with respect to FIGS. 1 and 2, above. In some embodiments, method 300 can include providing a computer portal 302, receiving a first request 304, configuring a modular fitness activity facility 306, storing preference data 308, preparing access credentials 310, receiving a second request 312, and reconfiguring the modular fitness activity facility 314. Although the method 300 is shown as a series of steps or operations for clarity, embodiments of the method 300 or any other method, process, or algorithm described in connection with the embodiments of the present disclosure can be performed in various orders and/or concurrently. Additionally, operations in accordance with the present disclosure can be performed with other operations not presented and described herein. Furthermore, one or more aspects of the method 300 may be omitted in some embodiments.

A computer portal accessible by computer devices, such as computer device 202 of FIG. 2, is provided at operation 302. The computer portal can be visually represented using the graphical user interface 200 of FIG. 2 and be configured to include a plurality of fitness equipment options and a plurality of non-fitness material options. In some embodiments, operation 302 can include maintaining the computer portal on a web server, for example, using a third party web hosting company for making the computer portal Internet-accessible using conventional computer devices.

A first request can be received from a first user at operation 304. A user interacting with the computer portal can select one or more of the fitness equipment options and/or the non-fitness material options in order to indicate their preferences for configuring a modular fitness activity facility. For example, where the user of the computer portal is a personal trainer that is preparing an exercise routine for his or her client, and the exercise routine is to include running on a treadmill, bicep curls with dumbbells, and throwing a medicine ball, the user can select ‘treadmill,’ ‘dumbbell,’ and ‘medicine ball’ from the list of options for fitness equipment. If the user also wants to record the client's workout for the client to review later or for the user to include in personal training footage, or if the user wants to livestream the client's workout as part of an online exercise program, the user can select ‘Internet-connected camera’ from the non-fitness materials. The selected fitness equipment and non-fitness materials can be transmitted to the fitness facility in which the modular fitness activity facility is located as the first request. The fitness facility can receive the first request on a computing device separate from the computing device from which the first request was transmitted or generated.

A modular fitness activity facility can be configured in accordance with the first request at operation 306. Configuring the modular fitness activity facility in accordance with the first request can include removably disposing the selected fitness equipment and non-fitness materials indicated via the first request within the enclosed structure of the modular fitness activity facility. In some embodiments, configuring the modular fitness activity facility can include removing any equipment or materials previously disposed therein and then moving the selected fitness equipment and non-fitness materials into the room.

The selected fitness equipment and non-fitness materials can be included in a set of preference data stored at operation 308. In some embodiments, the set of preference data can include data indicative of the selected fitness equipment and non-fitness materials and/or any user comments entered within the computer portal provided at operation 302. In some embodiments, the set of preference data can be automatically recorded into a file upon the first request being received at operation 304. In some embodiments where the user transmitting the first request has a user profile with the fitness facility, operation 308 can include storing the set of preference data in association with the user profile. The user can later refer to his or her user profile to review previously transmitted requests and the selected fitness equipment and non-fitness materials associated therewith before taking the time to cause a new request to be generated and transmitted, for example, where the user desires the same configuration as before. In some embodiments, operation 308 can be performed prior to the configuration of operation 306.

Access credentials for accessing the configured modular fitness activity facility can be prepared at operation 310. In some embodiments, for example, where a locking mechanism on an entrance to the configured modular fitness activity facility is a key card reader, preparing the access credentials can include preparing a key card for the user to enter the configured modular fitness activity facility with. In some embodiments, for example, where the user is not the person who will be actually exercising using the configured fitness equipment and non-fitness materials, operation 310 can include preparing multiple copies of the access credentials. For example, the first request received at operation 304 can include a user request for a number of access credentials.

A second request can be received from a second user at operation 312. The second request can be received before, during, or after the first user exercises in the modular fitness activity facility configured at operation 306. The second request can include indications that the second user selected fitness equipment and non-fitness materials different from those of the first request using the computer portal. For example, the computer portal may not indicate to the second user that his or her second request differs from the first request of the first user; however, once the second request is received at operation 312, the receiving personnel at the fitness facility can review the second request to determine that the selected fitness equipment and non-fitness materials of the second request differ from those of the first. In some embodiments, operation 312 can include the computer portal comparing the received second request against the first request to identify the fitness equipment or non-fitness materials that need to be changed to facilitate the second request.

The modular fitness activity facility can be reconfigured in accordance with the second request at operation 314. Reconfiguring the modular fitness activity facility in accordance with the second request can include removing the selected fitness equipment and non-fitness materials indicated via the first request from the enclosed structure of the modular fitness activity facility and, in their place, removably disposing the selected fitness equipment and non-fitness materials indicated via the second request within the enclosed structure. In some embodiments, for example, where certain fitness equipment or non-fitness materials are indicated in both the first request and the second request, such fitness equipment or non-fitness materials can remain in the modular fitness activity facility. The personnel of the fitness facility can clean the remaining fitness equipment or non-fitness materials as necessary before the second user enters the reconfigured modular fitness activity facility.

While the invention has been described in connection with certain embodiments, it is to be understood that the invention is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A modular fitness activity facility, comprising:
an enclosed structure defined by a plurality of connecting walls, at least one wall of the plurality of connecting walls including an entrance, the entrance having a locking mechanism restricting access to an interior of the enclosed structure by persons without corresponding access credentials;
at least one fitness equipment removably disposed within the interior of the enclosed structure; and
at least one non-fitness material removably disposed within the interior of the enclosed structure,
wherein one or more of the at least one fitness equipment or the at least one non-fitness material is removably disposed within the interior of the enclosed structure in response to an indication by a user, the indication including a request for the one or more of the at least one fitness equipment or the at least one non-fitness material.

2. The modular fitness activity facility of claim 1, wherein the at least one fitness equipment and the at least one non-fitness material can be removed from the interior of the enclosed structure after a use by the user in order to configure the interior of the enclosed structure to include other fitness equipment or non-fitness materials selected by a different user.

3. The modular fitness activity facility of claim 1, wherein the at least one fitness equipment is a cardiovascular equipment including one of a treadmill, an elliptical machine, a recumbent bicycle, an upright bicycle, an assault bicycle, a spin bicycle, or a concept two rower machine.

4. The modular fitness activity facility of claim 1, wherein the at least one fitness equipment is a strength-resistance equipment including one of a squat rack, a Smith machine, a dumbbell, a barbell, a resistance tube, an Olympic bar, or a weight tree.

5. The modular fitness activity facility of claim 1, wherein the at least one fitness equipment is an aerobic equipment including one of a suspension training system, a plyometric box, a balancing or stability equipment, an agility ladder, a medicine ball, a battle rope, a climbing rope, a mat, an agility tool, or a stretching equipment.

6. The modular fitness activity facility of claim 1, wherein the at least one fitness equipment is a therapeutic equipment including one of a foam or rumble roller, an exercise ball, or a sauna.

7. The modular fitness activity facility of claim 1, wherein the at least one fitness equipment is a recreational equipment including one of a golf simulator or a golf session training system.

8. The modular fitness activity facility of claim 1, wherein the at least one non-fitness material is one or more of a technological material, a communications material, an ambiance material, or a safety material.

9. The modular fitness activity facility of claim 8, wherein the technological material is one of a television, an Internet-connected computing device, an Internet-connected camera, a chalkboard, a whiteboard, or a speaker system.

10. The modular fitness activity facility of claim 8, wherein the communications material is one of an intercom or a telephone.

11. The modular fitness activity facility of claim 8, wherein the ambiance material is one of a light or color changing picture frame, a light strip including color changing features, or a mirror.

12. The modular fitness activity facility of claim 8, wherein the safety material is one of a closed circuit camera or a request assistance interface.

13. The modular fitness activity facility of claim 1, wherein the locking mechanism of the entrance is a key card reader and the corresponding access credentials include a key usable within the key card reader to grant access through the entrance.

14. A method of providing a modular fitness activity facility, comprising:
providing a computer portal accessible by computer devices, the computer portal configured to include a plurality of fitness equipment options and a plurality of non-fitness material options selectable by users to indicate configurations of the modular fitness activity facility;
receiving, at a first computing device, a first request from a first user, the first request including an indication of at least one fitness equipment and at least one non-fitness material to be included within an interior of an enclosed structure of the modular fitness activity facility, the first request transmitted by a second computing device of the first user in response to the first user accessing the computer portal using the second computing device; and
configuring the modular fitness activity facility by removably disposing the at least one fitness equipment and the at least one non-fitness material indicated in the first request within the interior of the enclosed structure of the modular fitness activity facility.

15. The method of claim 14, further comprising:
receiving, at the first computing device, a second request from a second user, the second request including an indication of at least one other fitness equipment and at least one other non-fitness material to be included within the interior of the enclosed structure of the modular fitness activity facility, the second request transmitted by a third computing device associated with the second user in response to the second user accessing the computer portal using the third computing device; and
reconfiguring the modular fitness activity facility by removing the at least one fitness equipment and the at least one non-fitness material indicated in the first request from the interior of the enclosed structure and removably disposing the at least one other fitness equipment and the at least one other non-fitness material indicated in the second request within the interior of the enclosed structure.

16. The method of claim 14, further comprising:
storing preference data indicative of the first request in a user profile associated with the first user such that the preference data is referenced by the first user to cause a subsequent request to be transmitted to the first computing device, the subsequent request including the indication of the at least one fitness equipment and the at least one non-fitness material.

17. The method of claim 14, further comprising:
preparing access credentials for the first user to access the interior of the enclosed structure of the modular fitness activity facility.

18. The method of claim 14, wherein the at least one fitness equipment comprises one of a cardiovascular equipment, a strength-resistance equipment, an aerobic equipment, a therapeutic equipment, or a recreational equipment.

19. The method of claim 14, wherein the at least one non-fitness material comprises one of a technological material, a communications material, an ambiance material, or a safety material.

20. A modular fitness activity facility, comprising:
an enclosed structure defined by a plurality of connecting walls, at least one wall of the plurality of connecting walls including an entrance, the entrance having a locking mechanism restricting access to an interior of the enclosed structure by persons without corresponding access credentials, the interior of the enclosed structure removably including a combination of equipment including a plurality of cardiovascular equipment, strength-resistance equipment, aerobic equipment, therapeutic equipment, recreational equipment, technological materials, communications materials, ambiance materials, or safety materials,
wherein the combination of equipment is selected by a user having the corresponding access credentials, the selection of the combination of equipment being indicated by a first request generated using a computer portal for browsing available equipment for removable inclusion within the interior of the enclosed structure, the computer portal configured to store preference data associated with the selection of the combination of equipment in connection with a user profile associated with the user such that the user can reference the preference data to cause a second request similar to the first request to be generated using the computer portal, and
wherein the interior of the enclosed structure is configured to include the combination of equipment in response to the user selection of the combination of equipment being indicated using the computer portal such that the interior of the enclosed structure can be emptied after a use by the user in order to configure the interior of the enclosed structure to include a second combination of equipment selected by a second user.
